(19) United States
(12) Patent Application Publication
(10) Pub. No.: US 2025/0234096 A1
(43) Pub. Date: Jul. 17, 2025

(54) OPTICAL APPARATUS

(71) Applicant: Panasonic Intellectual Property Management Co., Ltd., Osaka (JP)

(72) Inventors: Yusuke KITAGAWA, Hyogo (JP); Kiyoshi HASHIMOTODANI, Kyoto (JP)

(21) Appl. No.: 18/844,838

(22) PCT Filed: Mar. 8, 2023
(86) PCT No.: PCT/JP2023/008835

§ 371 Date: Sep. 6, 2024

(30) Foreign Application Priority Data
Mar. 15, 2022 (JP) 2022-040377

(51) Int. Cl. H04N 23/74; G01N 21/01; G01N 21/25; G01N 21/27; H04N 23/21; H04N 23/56; H04N 23/80

(52) U.S. Cl. CPC H04N 23/74; G01N 21/01; G01N 21/255; G01N 21/27; H04N 23/21; H04N 23/56; H04N 23/80; G01N 2201/0635

(57) ABSTRACT

An optical apparatus includes: a light source unit that structures light into a plurality of light and dark line patterns and emits the light structured; a photodetector that detects, when an object is irradiated with the light emitted by the light source unit, light from the object; a modulator that modulates a predetermined region of the object; a controller that synchronizes the irradiation of the light emitted by the light source unit with the modulator; and a calculator that reconstructs a line image of the object by performing a cross-correlation operation between a signal outputted from the photodetector and a corresponding one of the plurality of light and dark line patterns.

### TECHNICAL FIELD

The present disclosure relates to an optical apparatus.

### BACKGROUND ART

Patent Literature (PTL) 1 discloses a device for measuring a material by using ghost imaging. The device for measuring a material described in PTL 1 includes: a light source that emits light having a spatial intensity distribution; a detector that detects light transmitted through, or reflected by, an object to be measured; and a calculator that estimates a characteristic of the object to be measured based on information on the detected light and information on the irradiation light.

### CITATION LIST

### Patent Literature

### PTL 1

WO2016/027797

### SUMMARY OF INVENTION

### Technical Problem

The light detected by the detector of the above-described conventional device for measuring a material, however, is light containing information on the entire portion of the object to be measured through which the light has been transmitted. In other words, information on a specific region of the object to be measured is unable to be obtained.

In light of the above, the present disclosure provides an optical apparatus capable of obtaining information on a specific region of an object.

### Solution to Problem

An optical apparatus according to an aspect of the present disclosure includes: a light source unit that structures light into a plurality of light and dark line patterns and emits the light structured; a photodetector that detects, when an object is irradiated with the light emitted by the light source unit, light from the object; a modulator that modulates a predetermined region of the object; a synchronization controller that synchronizes the irradiation of the light emitted by the light source unit with the modulator; and a calculator that reconstructs a line image of the object by performing a cross-correlation operation between a signal outputted from the photodetector and a corresponding one of the plurality of light and dark line patterns.

### Advantageous Effects of Invention

According to the present disclosure, information on a specific region of an object can be obtained.

### BRIEF DESCRIPTION OF DRAWINGS

FIG. 1 is a diagram illustrating a configuration of an optical apparatus according to Embodiment 1.

FIG. 2 is a diagram illustrating a method for reconstructing a line image using the optical apparatus according to Embodiment 1.

FIG. 3A is a diagram illustrating an example of ultrasonic irradiation performed by the optical apparatus according to Embodiment 1.

FIG. 3B is a diagram illustrating another example of ultrasonic irradiation performed by the optical apparatus according to Embodiment 1.

FIG. 4 is a diagram illustrating a configuration of an optical apparatus according to a variation of Embodiment 1.

FIG. 5 is a diagram illustrating a configuration of an optical apparatus according to Embodiment 2.

FIG. 6 is a diagram illustrating a configuration of an optical apparatus according to Embodiment 3.

FIG. 7 is a diagram illustrating a configuration of an optical apparatus according to a variation of Embodiment 3.

### DESCRIPTION OF EMBODIMENTS

### Summary of Present Disclosure

An optical apparatus according to an aspect of the present disclosure includes: a light source unit that structures light into a plurality of light and dark line patterns and emits the light structured; a photodetector that detects, when an object is irradiated with the light emitted by the light source unit, light from the object; a modulator that modulates a predetermined region of the object; a synchronization controller that synchronizes the irradiation of the light emitted by the light source unit with the modulator; and a calculator that reconstructs a line image of the object by performing a cross-correlation operation between a signal outputted from the photodetector and a corresponding one of the plurality of light and dark line patterns.

For example, an ultrasonic generator that generates ultrasound and irradiates a predetermined region with the generated ultrasound can be used as the modulator described above. In this case, light can be modulated (specifically, enhanced) in a region where the ultrasound for irradiation and the light intersect. Thus, by irradiating such a region with light in synchronization with ultrasound, transmitted light reflecting characteristics of the region can be detected by the photodetector. Thus, information on the specific region of the object can be obtained.

For example, a method utilizing light, electromagnetic waves, temperature, stress, etc. may be used as a method for modulating such a predetermined region. That is, the modulator may be at least one of a light source that irradiates the predetermined region with light, an electromagnetic wave generator that irradiates the predetermined region with electromagnetic waves, a temperature control device that heats and/or cools the predetermined region, or a stress generator (a pressurizer or a pressure reducer) that applies a stress to the predetermined region.

For example, the light source unit may include: a light source; and a structuring unit that structures light emitted by the light source into the plurality of light and dark line patterns.

An optical apparatus according to another aspect of the present disclosure includes: a light source unit that emits light; a structuring unit that structures, when an object is irradiated with the light emitted by the light source unit, light from the object into a plurality of light and dark line patterns; a photodetector that detects the light structured by the structuring unit; and a calculator that reconstructs a line image of the object by performing a cross-correlation operation between a signal outputted from the photodetector and a corresponding one of the plurality of light and dark line patterns.

According to this, when the ultrasonic generator is used as the modulator, the light can be modulated (specifically, enhanced) in the region where the ultrasound for irradiation and the light intersect. Thus, by irradiating such a region with light in synchronization with ultrasound, reflected light reflecting characteristics of the region can be detected by the photodetector. Thus, information on the specific region of the object can be obtained.

For example, the structuring unit may be one of a digital mirror device, an active matrix liquid crystal device, or a spatial light modulator.

This can facilitate the structuring of light, i.e., the formation of the light and dark line patterns.

For example, the light emitted by the light source unit may contain a wavelength component of at least 2 μm and at most 10 μm.

This allows the mid-infrared band to be used, for example, for analyzing a component of the object or inspecting the presence or absence of foreign matter other than the object.

For example, the light from the object may be reflected light resulting from the object reflecting at least part of the light emitted by the light source unit.

Therefore, this is useful for analyzing an object with low transmittance.

For example, the light from the object may be transmitted light resulting from the object transmitting at least part of the light emitted by the light source unit.

Therefore, this is useful for analyzing an object with high transmittance.

Embodiments will be specifically described below with reference to the drawings.

Each of the embodiments described below shows a general or specific example. The numerical values, shapes, materials, elements, the arrangement and connection of the elements, steps, the processing order of the steps, etc. shown in the following embodiments are mere examples, and therefore do not limit the scope of the present disclosure. Among the elements in the following embodiments, those not recited in any one of the independent claims are described as optional elements.

Each of the figures is a schematic diagram and is not necessarily drawn in a strict sense. Therefore, the scale, for example, is not necessarily the same in these figures. In addition, substantially the same configurations are denoted by the same reference numeral throughout the figures, and redundant descriptions will be omitted or simplified.

### Embodiment 1

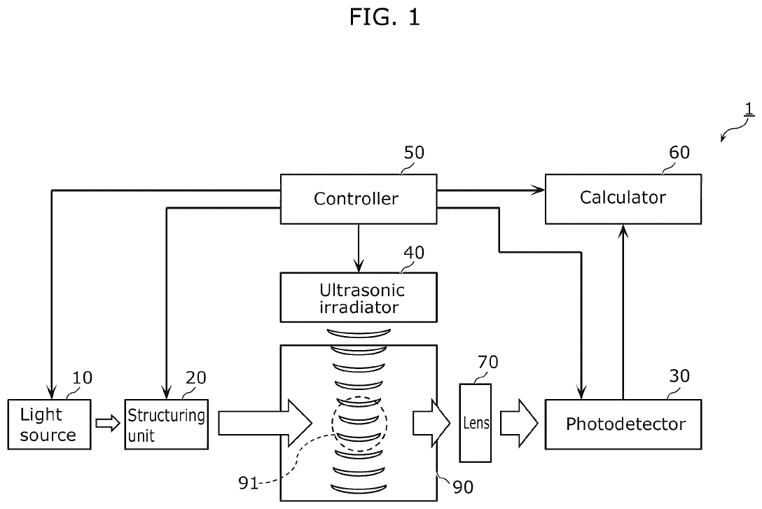

First, a configuration of an optical apparatus according to Embodiment 1 will be described with reference to FIG. 1. FIG. 1 is a diagram illustrating the configuration of optical apparatus 1 according to the present embodiment.

Optical apparatus 1 shown in FIG. 1 is an apparatus for inspecting object 90, for example, by detecting, when object 90 is irradiated with light, light from object 90. Specifically, optical apparatus 1 modulates a predetermined region inside object 90. In the present embodiment, when irradiated with ultrasound, the light is modulated (specifically, enhanced) in region 91 where the ultrasound and the light intersect. By irradiating region 91 with the light in synchronization with the ultrasound, the light reflecting characteristics of region 91 can be detected by a photodetector. This allows information on specific region 91 of object 90 to be obtained. The modulation method employs ultrasound, for example, but may employ light, electromagnetic waves, temperature, or stress, for example.

An example of object 90 is a medicine in tablet form or powder form. Optical apparatus 1 can be used to detect foreign matter contained in the medicine in tablet form or powder form. Note that object 90 is not limited to such a medicine in tablet form or powder form, but may also be a food item or an industrial product. Object 90 is not limited to solid matter (solid), but may also be liquid or gas.

As shown in FIG. 1, optical apparatus 1 includes light source 10, structuring unit 20, photodetector 30, ultrasonic irradiator 40, controller 50, calculator 60, and lens 70. Although not shown in FIG. 1, optical apparatus 1 may include an irradiation optical system for irradiating object 90 with light and an objective optical system for collecting light from object 90.

Light source 10 emits light containing a wavelength component that passes through object 90. In the present embodiment, light source 10 emits mid-infrared light. The mid-infrared light is, for example, light with an intensity equal to or higher than a predetermined level in a wavelength band of at least 2 μm and at most 10 μm.

The light emitted by light source 10 may be narrow-band light. For example, to detect a component of object 90, narrow-band light that can be absorbed by the component to be detected is used. The narrow-band light has a half width of 2 μm or less, for example, but the half width is not limited to such a value. The half width of the narrow-band light may be 1 μm or less, or 0.5 μm or less. The narrower the half width, the less susceptible to absorption by components other than the component to be detected. Therefore, the detection accuracy can be improved.

Light source 10 may change the wavelength of the light to be emitted. For example, light source 10 is an infrared wavelength-tunable laser such as a quantum cascade (QC) laser. Alternatively, light source 10 may be a wavelength-selective light source including a wide-band light source and a grating, for example. Alternatively, light source 10 may include a wide-band light source and one or more filters.

For example, the wide-band light source emits light with an intensity equal to or higher than a predetermined level in a wavelength band of at least 2 μm and at most 10 μm. For example, the wide-band light source is a light emitting diode (LED), a halogen lamp, a supercontinuum light source, or a super-luminescent diode light source.

Each of the one or more filters is a bandpass filter configured to transmit light in a corresponding band and block light outside the corresponding band. Light source 10 can emit light in the corresponding band by passing light emitted by the wide-band light source through one filter selected from among the one or more filters. By changing the filter to be selected, light source 10 may be able to emit light in each band in a time-divisional manner.

Structuring unit 20 structures the light from light source 10 into a plurality of light and dark line patterns. Such a light and dark pattern is represented by a “light” area and a “dark” area for each of a plurality of micro-regions arranged in an array in a two-dimensional plane. In FIG. 1, structuring unit 20 is a transmissive device, and can change transmittance for each of the micro-regions. Micro-regions with high transmittance are “light”, and micro-regions with low transmittance are “dark”. Specifically, structuring unit 20 is an active matrix liquid crystal device or a spatial light modulator, for example. Note that a reflective device such as a digital mirror device (DMD) may also be used as structuring unit 20. Structuring unit 20 is disposed between light source 10 and object 90.

Structuring unit 20 switches among the plurality of light and dark patterns in a time-divisional manner based on control by controller 50. For example, the plurality of light and dark patterns are randomly generated based on a predetermined algorithm. The number of the light and dark patterns is in the hundreds or more, but may also be in the thousands or more, or in the tens of thousands or more. The greater the number of the light and dark patterns, the better the quality of a reconstructed line image. Conversely, by reducing the number of the light and dark patterns, time required for measurement can be reduced.

The number of the micro-regions corresponds to the number of pixels in the reconstructed line image. Therefore, by increasing the number of the micro-regions, a high-definition line image can be obtained.

When object 90 is irradiated with the light from light source 10, photodetector 30 detects light from object 90. In the present embodiment, object 90 is irradiated with the light structured by structuring unit 20, and photodetector 30 detects transmitted light transmitted through object 90 out of the structured light. Photodetector 30 outputs a signal corresponding to the intensity of the detected reflected light. The timing at which photodetector 30 outputs the signal is controlled by controller 50 so as to synchronize with the timing of the switching among the light and dark patterns. In other words, for each of the light and dark patterns, photodetector 30 outputs a signal corresponding to the intensity of light (specifically, transmitted light) from object 90. The signals outputted from photodetector 30 can have one-to-one correspondence with the light and dark patterns.

For example, photodetector 30 is a single-pixel infrared photodetector. For example, an HgCdTe detector, an InSb detector, or a bolometer can be used as the infrared photodetector.

In the present embodiment, since a single-pixel detector can be used as photodetector 30, the size of photodetector 30 can be reduced. Moreover, since a large light-receiving area can be ensured in one pixel, the sensitivity can be increased, or the dynamic range can be extended. Furthermore, photodetectors with sensitivity in the mid-infrared band are generally expensive. Since a single-pixel detector with a simple configuration and a small size can be used as photodetector 30, cost reduction can also be achieved.

Ultrasonic irradiator 40 is an example of a modulator that modulates predetermined region 91 of object 90. Ultrasonic irradiator 40 irradiates predetermined region 91 of object 90 with ultrasound. Specifically, ultrasonic irradiator 40 performs ultrasonic irradiation so that the ultrasound can be focused to a desired region on a surface of object 90 and inside object 90. For example, ultrasonic irradiator 40 is an ultrasonic phased array device.

The wavelength of the ultrasound can be adjusted according to the size of an area to be measured in object 90. Specifically, the wavelength of the ultrasound is set to be different from the size of the area to be measured. This can prevent a phase shift between edges of the area to be measured and unevenness in compression and rarefaction from occurring. Examples of the ultrasonic irradiation performed by ultrasonic irradiator 40 will be described later.

Region 91 where the ultrasound is focused corresponds to a region from which a user seeks to obtain information, and can be set to any region by instruction from the user. Although not shown in the figure, optical apparatus 1 may include an input interface device configured to receive user operations, such as a touch panel, or a physical operation button or lever.

Controller 50 performs overall control of optical apparatus 1. Specifically, controller 50 controls light source 10, structuring unit 20, photodetector 30, ultrasonic irradiator 40, and calculator 60. For example, controller 50 controls the timing of turning light source 10 on and off. Controller 50 controls timing at which structuring unit 20 switches among the plurality of light and dark patterns. Controller 50 also controls the timing of outputting a signal from photodetector 30 so as to correspond to each of the plurality of light and dark patterns. Controller 50 is an example of a synchronization controller that synchronizes the light irradiation and the ultrasonic irradiation. Controller 50 also outputs, to calculator 60, information to enable mapping between the light and dark patterns and the signals.

Calculator 60 reconstructs the line image of object 90 by performing a cross-correlation operation between the signals outputted from photodetector 30 and the light and dark patterns corresponding to the signals. Specific reconstruction techniques will be described later.

Controller 50 and calculator 60 are each implemented, for example, by an integrated circuit (IC) such as a large scale integration (LSI) circuit. Note that the integrated circuit is not limited to the LSI circuit, but may also be a dedicated circuit or a general-purpose processor. For example, controller 50 may be one or more microcontrollers. Such a microcontroller includes, for example, a nonvolatile memory in which a program is stored, a volatile memory, which is a temporary storage area for executing the program, input/output ports, and a processor for executing the program. Controller 50 or calculator 60 may be a programmable field programmable gate array (FPGA) or a reconfigurable processor in which the connection and configuration of circuit cells in the LSI circuit can be reconfigured. The functions to be performed by controller 50 or calculator 60 may be implemented in software or in hardware. Controller 50 may utilize a common hardware resource with calculator 60.

Lens 70 is a condenser lens that condenses the transmitted light transmitted through object 90 onto photodetector 30. A material suitable for the wavelength of the light to be transmitted is used to form lens 70. For example, a semiconductor such as germanium, calcium fluoride, or potassium bromide can be used as a material that transmits light in the mid-infrared band. Alternatively, a multi-layer film of various dielectrics or various metals may be used.

Optical apparatus 1 may include a different optical element instead of lens 70, as long as the different optical element can condense the light onto photodetector 30. Optical apparatus 1 may include an optical element for adjusting an optical path. Examples of such an optical element include a lens, a diffraction grating, a reflecting mirror, a light guide, and a beam homogenizer.

### [Reconstruction Method]

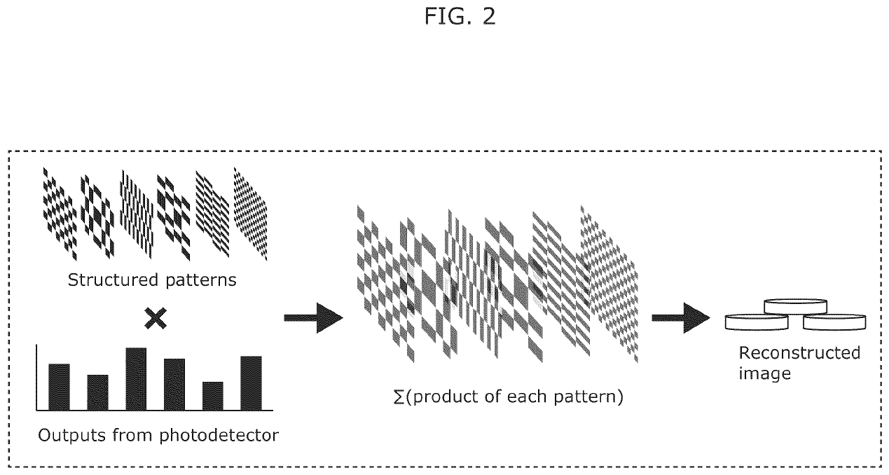

A method for reconstructing a line image using optical apparatus 1 will be described next with reference to FIG. 2.

FIG. 2 is a diagram illustrating the method for reconstructing a line image using optical apparatus 1 according to the present embodiment.

Calculator 60 reconstructs a line image using a plurality of light and dark patterns and signals from photodetector 30 corresponding to the plurality of light and dark patterns. As shown in FIG. 2, the line image is reconstructed by multiplying the plurality of light and dark patterns by the signals from photodetector 30 (cross-correlation operation), and summing the obtained products of those patterns.

Examples of the reconstruction method may include a technique referred to as ghost imaging and a technique referred to as single-pixel imaging.

### <Ghost Imaging>

In ghost imaging, when bᵣ represents a signal intensity from photodetector 30, bᵣ is expressed by Equation (1) described below.

$$\begin{matrix}[ Math . 1 ] & \\ {b}_{r} = \int {\int }_{s} {I}_{r} ( x , y ) T ( x , y ) dxdt & ( 1 )\end{matrix}$$

In Equation (1), the subscript r represents the irradiation order of the light and dark pattern. That is, bᵣ represents the intensity of a signal from photodetector 30 corresponding to light of the r-th light and dark pattern. Iᵣ represents the r-th light and dark pattern. x and y are the coordinates of the light and dark pattern. T(x, y) is the transmittance of object 90. When reflection from object 90 is used as in Embodiment 3 and its variation described below, T(x, y) is the reflectance of object 90.

Ghost imaging defines a quadratic correlation function, which is expressed by Equation (2) described below, to reconstruct the line image of object 90.

$$\begin{matrix}[ Math . 2 ] & \\ G ( x , y ) ≡ \frac{1}{n} {\sum }_{r = 1}^{n} ( {b}_{r} - 〈 b 〉 ) {I}_{r} ( x , y ) = 〈 bI ( x , y ) 〉 - 〈 b 〉 〈 I ( x , y ) 〉 & ( 2 )\end{matrix}$$

In this equation, n is the number of the light and dark patterns. <k> is the ensemble average and expressed by Equation (3) described below.

$$\begin{matrix}[ Math . 3 ] & \\ 〈 k 〉 = \frac{1}{N} {\sum }_{r = 1}^{N} {K}_{r} & ( 3 )\end{matrix}$$

G(x, y) in Equation (2) is the average of intensity changes in all of the light and dark patterns at the coordinates (x, y). Therefore, if the number n of the light and dark patterns is sufficiently large, G(x, y) will approach T(x, y) and can be regarded as the reconstructed line image.

### <Single-Pixel Imaging>

In single-pixel imaging, M linearly independent light and dark patterns are required in principle to obtain a line image consisting of N pixels. M is, for example, a value greater than or equal to N. For a linearly independent light and dark pattern I(x, y) consisting of N pixels, when B represents the corresponding signal intensity and T represents the image of object 90, relationship of Equation (4) described below is satisfied.

$$\begin{matrix}[ Math . 4 ] & \\ {B}_{M} = \frac{1}{M} {\sum }_{m = 1}^{M} {I}_{m} T & ( 4 )\end{matrix}$$

Since T can be expressed by T(x, y) as the line image, Equation (4) can be regarded as a matrix operation. That is, Equation (4) can be expressed by Equation (5) described below.

$$[ Math . 5 ]$$

$$B = H \cdot T \qquad ( 5 )$$

In other words, matrix T, i.e., line image T(x, y), can be obtained by using an inverse of matrix H. For example, an Hadamard matrix is used as matrix H.

The two techniques, ghost imaging and single-pixel imaging, have been described above as line image reconstruction techniques. However, any technique capable of reconstructing a line image can be used without being limited to any specific technique.

In optical apparatus 1 according to the present embodiment, ultrasonic irradiation is performed so that ultrasound is focused onto the predetermined region of object 90. The light is modulated in region 91 where the focused ultrasound and the irradiation light intersect. Specifically, the compression and rarefaction of the ultrasound cause a change in the refractive index of region 91, which can change the intensity of the passing light. Therefore, the light passing through region 91 can be enhanced by synchronizing the ultrasonic irradiation and the light irradiation.

In other words, the transmitted light that has been transmitted through object 90 becomes transmitted light reflecting the characteristics of region 91 where the focused ultrasound and the transmitted light intersect. That is, the transmitted light includes all the characteristics of object 90 on the path of the transmitted light, but the characteristics of region 91 where the ultrasound and the light intersect are enhanced, while characteristics of a region where the ultrasound and the light do not intersect are relatively suppressed. By detecting this transmitted light with photodetector 30, information on specific region 91 of object 90 can be obtained.

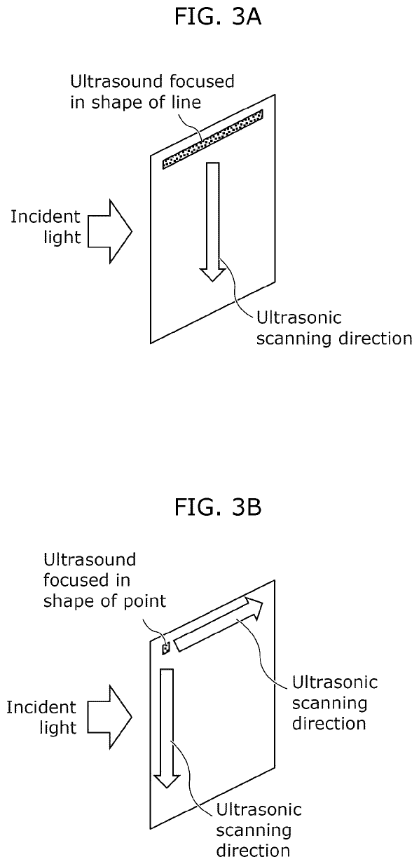

FIGS. 3A and 3B each show an example of the ultrasonic irradiation performed by optical apparatus 1 according to the present embodiment. As shown in FIG. 3A, ultrasonic irradiator 40 can focus ultrasound onto a region in the shape of a line. Such ultrasound focused in the shape of a line extends in one direction parallel to a plane perpendicular to a traveling direction of incident light. In the plane perpendicular to the traveling direction of the incident light, ultrasonic irradiator 40 scans the ultrasound focused in the shape of a line in a direction perpendicular to the direction in which the ultrasound focused in the shape of a line extends. This allows for the obtainment of information on the plane perpendicular to the traveling direction of the incident light, and thus allows for the reconstruction of the line image of that plane.

Note that ultrasonic irradiator 40 may focus ultrasound onto a region in the shape of a point as shown in FIG. 3B. Ultrasonic irradiator 40 two-dimensionally scans such ultrasound focused in the shape of a point in a plane perpendicular to a traveling direction of incident light. This allows for the obtainment of information on the plane perpendicular to the traveling direction of the incident light, and thus allows for the reconstruction of the line image of that plane.

### Variation

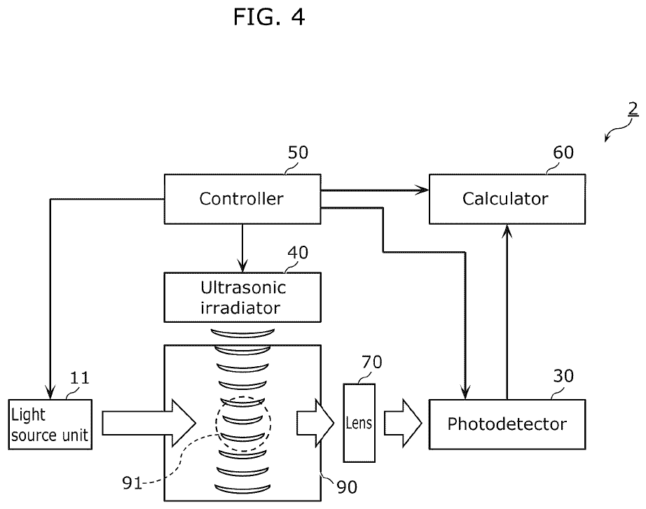

A variation of Embodiment 1 will be described below with reference to FIG. 4.

FIG. 4 is a diagram illustrating a configuration of optical apparatus 2 according to the present variation. Compared to optical apparatus 1 shown in FIG. 1, optical apparatus 2 includes light source unit 11 instead of light source 10 and structuring unit 20, as shown in FIG. 4.

Light source unit 11 structures light into a plurality of light and dark line patterns and emits the structured light. In other words, light source unit 11 has the functions of both light source 10 and structuring unit 20 described above. Specifically, light source unit 11 includes a plurality of light-emitting elements arranged two-dimensionally. The plurality of light-emitting elements can turn on and off independent of one another. A light and dark pattern is generated by turning the light-emitting elements on and off. For example, light source unit 11 is an LED array including LEDs as light-emitting elements.

As just described, optical apparatus 2, in which light source 10 and structuring unit 20 are integrated together, can also obtain information on a specific region as with optical apparatus 1.

### Embodiment 2

Embodiment 2 will be described next.

Embodiment 2 differs from Embodiment 1 in that a structuring unit is disposed on the side of a photodetector. The following description will focus on differences from Embodiment 1, and the description of similarities will be omitted or simplified.

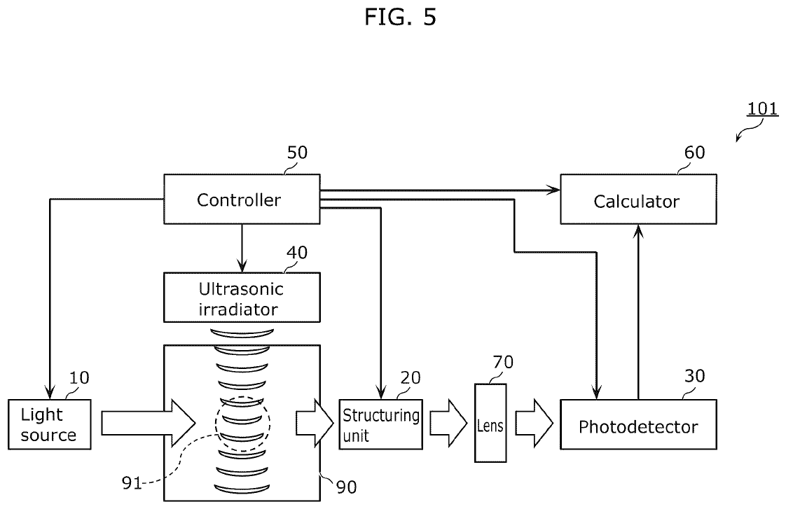

FIG. 5 is a diagram illustrating a configuration of optical apparatus 101 according to the present embodiment. As shown in FIG. 5, optical apparatus 101 differs from optical apparatus 1 shown in FIG. 1 in disposition of structuring unit 20. Specifically, structuring unit 20 is disposed between object 90 and photodetector 30. More specifically, structuring unit 20 is disposed between object 90 and lens 70.

In the present embodiment, when object 90 is irradiated with light from light source 10, structuring unit 20 structures light from object 90 (specifically, transmitted light) into a plurality of light and dark line patterns. As with Embodiment 1, a translucent device such as an active matrix liquid crystal device can be employed as structuring unit 20.

As with Embodiment 1, calculator 60 reconstructs a line image of object 90 by performing a cross-correlation operation between signals outputted from photodetector 30 and the light and dark patterns corresponding to the signals. Ghost imaging or single-pixel imaging can be employed as a specific reconstruction method.

As just described, even when the transmitted light from object 90 is structured, the line image can be reconstructed as with Embodiment 1. Optical apparatus 101 according to the present embodiment can obtain information on a specific region.

### Embodiment 3

Embodiment 3 will be described next.

Embodiment 3 differs from Embodiments 1 and 2 in that reflected light from an object is detected. The following description will focus on differences from Embodiments 1 and 2, and the description of similarities will be omitted or simplified.

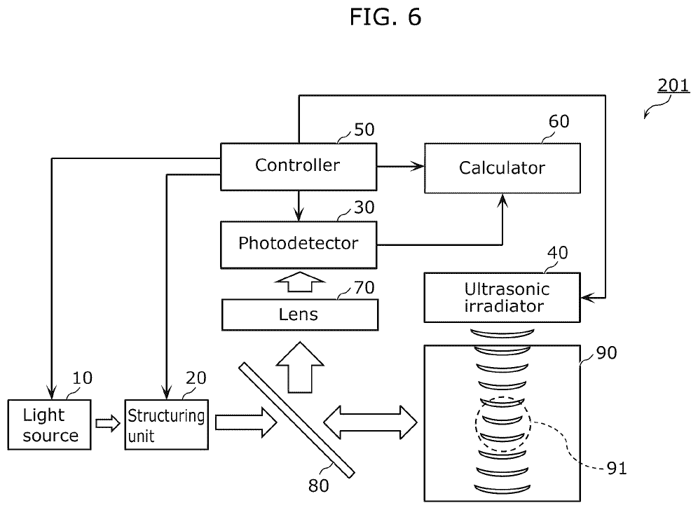

FIG. 6 is a diagram illustrating a configuration of optical apparatus 201 according to the present embodiment. As shown in FIG. 6, optical apparatus 201 differs in a positional relationship between light source 10 and structuring unit 20 as well as photodetector 30 and lens 70, and object 90. Specifically, photodetector 30 is disposed at a position where reflected light from object 90 is incident. The reflected light is, for example, light reflected in region 91 inside object 90 where focused ultrasound and irradiation light intersect.

Optical apparatus 201 includes half mirror 80. Half mirror 80 transmits at least part of light emitted by light source 10 and structured by structuring unit 20. Object 90 is irradiated with the light transmitted through half mirror 80, and at least part of the irradiation light is reflected by object 90. Half mirror 80 also reflects at least part of the light reflected by object 90 (i.e., reflected light). The light reflected by half mirror 80 is condensed onto photodetector 30 through lens 70.

The provision of half mirror 80 allows the optical axis of the light directed to object 90 for irradiation and the optical axis of the reflected light from object 90 to be aligned with each other. This can improve the collection efficiency of the reflected light and reduce the intrusion of ambient light, which becomes a factor of noise.

As just described, even when the reflected light from object 90 is detected, a line image can be reconstructed as with Embodiment 1. Optical apparatus 201 according to the present embodiment can obtain information on a specific region. Optical apparatus 201 is particularly suitable for obtaining information on a region of object 90 having low transmittance and located in the vicinity of a surface of an incident plane of light.

Note that structuring unit 20 may be disposed on the side of photodetector 30 as with Embodiment 2, instead of being disposed on the side of light source 10.

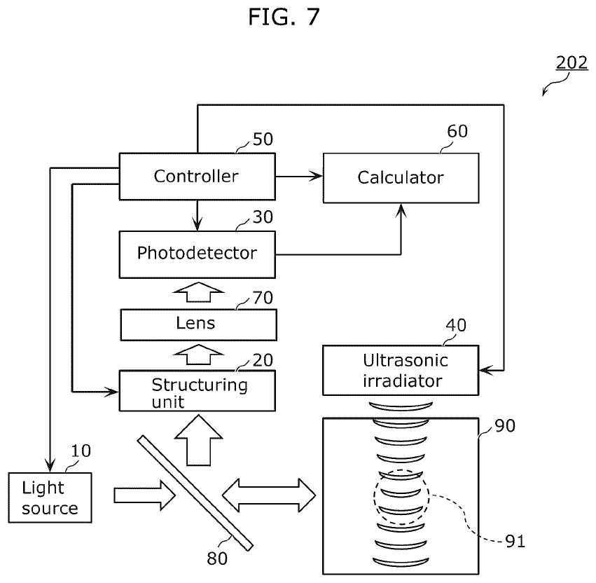

FIG. 7 is a diagram illustrating a configuration of optical apparatus 202 according to a variation of Embodiment 3. As shown in FIG. 7, optical apparatus 202 differs from the configuration of optical apparatus 201 shown in FIG. 6 in disposition of structuring unit 20.

In the present variation, structuring unit 20 is disposed between object 90 and photodetector 30. Specifically, structuring unit 20 is disposed between half mirror 80 and lens 70. In other words, when object 90 is irradiated with light from light source 10, structuring unit 20 structures light from object 90 (specifically, reflected light) into a plurality of light and dark line patterns.

As just described, even when the reflected light from object 90 is structured, a line image can be reconstructed as with Embodiment 3. Optical apparatus 202 according to the present variation can obtain information on a specific region.

### Other Embodiments

Although the optical apparatuses according to the one or more aspects have been described above with reference to the embodiments, the present disclosure is not limited to those embodiments. Forms obtained by making various modifications to the above embodiments that can be conceived by those skilled in the art, as well as forms obtained by combining structural components in different embodiments, without materially departing from the spirit of the present disclosure, may be included in the scope of the present disclosure.

For example, light emitted by a light source may be light on the longer wavelength side than mid-infrared light. Specifically, the light emitted by the light source may be far-infrared light with a wavelength band of at least 10 μm and at most 30 μm, or terahertz waves with a wavelength band of at least 30 μm and at most 3 mm.

Alternatively, light emitted by a light source may be light on the shorter wavelength side than visible light. Specifically, the light emitted by the light source may be ultraviolet light with a wavelength band of at least 10 nm and at most 400 nm, X-rays, or electron beams.

Alternatively, light emitted by a light source may be excitation light that excites object 90. In this case, when object 90 is irradiated with the light, object 90 is excited and generates fluorescence. A photodetector may detect the fluorescence from object 90 as light from object 90.

A photodetector may be an image sensor having a plurality of pixels. The number of the pixels in the image sensor may be less than the number of micro-regions of a structuring unit. A line image with a better image quality can be reconstructed by using detection results of the plurality of pixels.

A photodetector may include a wavelength conversion member. The wavelength conversion member is an upconverting wavelength conversion member, for example, and converts light in the mid-infrared band into visible light or near-infrared light. This allows the photodetector to employ an inexpensive visible light sensor or near-infrared light sensor.

Each of the embodiments described above may be changed, replaced, added, omitted, etc. in various ways within the scope of the appended Claims or their equivalents.

### INDUSTRIAL APPLICABILITY

The present disclosure can be used for various analyzing apparatuses and inspection apparatuses to analyze components of an object or identify contamination by foreign matter, for example.

[Reference Signs List]

| | |
|---|---|
| 1, 2, 101, 201, 202 | Optical apparatus |
| 10 | Light source |
| 11 | Light source unit |
| 20 | Structuring unit |
| 30 | Photodetector |
| 40 | Ultrasonic irradiator |
| 50 | Controller |
| 60 | Calculator |
| 70 | Lens |
| 80 | Half mirror |
| 90 | Object |
| 91 | Region |

1. An optical apparatus comprising:
a light source unit that structures light into a plurality of light and dark line patterns and emits the light structured;
a photodetector that detects, when an object is irradiated with the light emitted by the light source unit, light from the object;
a modulator that modulates a predetermined region of the object;
a synchronization controller that synchronizes the irradiation of the light emitted by the light source unit with the modulator; and
a calculator that reconstructs a line image of the object by performing a cross-correlation operation between a signal outputted from the photodetector and a corresponding one of the plurality of light and dark line patterns.

2. The optical apparatus according to claim 1,
wherein the light source unit includes:
a light source; and
a structuring unit that structures light emitted by the light source into the plurality of light and dark line patterns.

3. An optical apparatus comprising:
a light source unit that emits light;
a structuring unit that structures, when an object is irradiated with the light emitted by the light source unit, light from the object into a plurality of light and dark line patterns;
a photodetector that detects the light structured by the structuring unit; and
a calculator that reconstructs a line image of the object by performing a cross-correlation operation between a signal outputted from the photodetector and a corresponding one of the plurality of light and dark line patterns.

4. The optical apparatus according to claim 2,
wherein the structuring unit is one of a digital mirror device, an active matrix liquid crystal device, or a spatial light modulator.

5. The optical apparatus according to claim 1,
wherein the modulator is an ultrasonic generator that generates ultrasound.

6. The optical apparatus according to claim 1,
wherein the light emitted by the light source unit contains a wavelength component of at least 2 μm and at most 10 μm.

7. The optical apparatus according to claim 1,
wherein the light from the object is reflected light resulting from the object reflecting at least part of the light emitted by the light source unit.

8. The optical apparatus according to claim 1,
wherein the light from the object is transmitted light resulting from the object transmitting at least part of the light emitted by the light source unit.

9. The optical apparatus according to claim 3,
wherein the structuring unit is one of a digital mirror device, an active matrix liquid crystal device, or a spatial light modulator.

10. The optical apparatus according to claim 3,
wherein the light emitted by the light source unit contains a wavelength component of at least 2 μm and at most 10 μm.

11. The optical apparatus according to claim 3,
wherein the light from the object is reflected light resulting from the object reflecting at least part of the light emitted by the light source unit.

12. The optical apparatus according to claim 3,
wherein the light from the object is transmitted light resulting from the object transmitting at least part of the light emitted by the light source unit.
